(19) United States
(12) Patent Application Publication
(10) Pub. No.: US 2020/0122304 A1
(43) Pub. Date: Apr. 23, 2020

(54) Socket wrench

(71) Applicant: GUOCHANG COLD FORGING CO., LTD., Taichung City (TW)

(72) Inventor: Ting-Wei Chu, Taichung City (TW)

(21) Appl. No.: 16/166,951

(22) Filed: Oct. 22, 2018

(51) Int. Cl. B25B 13/46

(52) U.S. Cl. CPC B25B 13/463

(57) ABSTRACT

A socket wrench contains: a body and at least one drive assembly. Each drive assembly includes a socket, a spring, a first fitting element, and a second fitting element. The body includes two control members. The socket has a ratchet section, a first accommodation groove, a second accommodation groove, a communication groove, two first positioning elements, and two second positioning elements. The first fitting element has a first engagement section, a second engagement section, a third accommodation groove, and a first trench. The second fitting element has a third engagement section, a fourth engagement section, a fourth accommodation groove, and a second trench. The spring is accommodated in the communication groove and abuts against the first fitting element and the second fitting element so that the first engagement section and the second engagement section flush with the first accommodation groove and the second accommodation groove individually.

### FIELD OF THE INVENTION

The present invention relates to a socket wrench, an end of which is capable of rotating screw bolts or screws of different sized by using the first, second, third, and fourth accommodation grooves.

### BACKGROUND OF THE INVENTION

A screw bolt and a nut are connected or removed by a socket or a socket tool so to as to be applicable for building construction, car repair and maintenance, or furniture assembly. The screw bolt and a nut are formed in a polygon shape, such as a square, hexagon or octagon shape.

However, the socket and the socket tool cannot be used to rotate the screw bolt and the nut cannot of specific shapes, such as a gear, ratchet, or start shape.

The present invention has arisen to mitigate and/or obviate the afore-described disadvantages.

### SUMMARY OF THE INVENTION

The primary aspect of the present invention is to a socket wrench, an end of which is capable of rotating screw bolts or screws of different sized by using the first, second, third, and fourth accommodation grooves.

To obtain the above mentioned aspect, a socket wrench provided by the present invention contains: a body and at least one drive assembly.

Each of the at least one drive assembly includes a socket, a spring, a first fitting element, and a second fitting element.

The body includes two control members fixed on the two ends thereof respectively, and the socket has a ratchet section formed on an outer wall thereof so as to mate with each of the two control members.

The socket has a first accommodation groove and a second accommodation groove which are formed on two ends of the socket individually so as to receive two polygonal workpieces of different sizes respectively, wherein a diameter of the first accommodation groove is different from that of the second accommodation groove, and the socket further has a communication groove communicating with and defined between the first accommodation groove and the second accommodation groove, wherein the first fitting element is movably accommodated in the first accommodation groove and the communication groove, and the first fitting element has a first engagement section, a diameter of which corresponds to the first accommodation groove, the first fitting element further has a second engagement section fitted with the communication groove, wherein a length of the first engagement section is less than a depth of the first accommodation groove, the first fitting element further has a third accommodation groove, a diameter of which is less than the first accommodation groove, and the third accommodation groove is formed on the first engagement section, wherein the first fitting element further has a first trench defined on an outer wall of the second engagement section, and the socket has at least one first positioning element mounted in the communication groove thereof and located in the first trench so as to limit a sliding distance of the first fitting element.

The second fitting element is movably accommodated in the second accommodation groove and the communication groove, and the second fitting element has a third engagement section, a diameter of which corresponds to the second accommodation groove, the second fitting element further has a fourth engagement section fitted with the communication groove, wherein a length of the third engagement section is less than a depth of the second accommodation groove, and the second fitting element further has a fourth accommodation groove, a diameter of which is less than the second accommodation groove, wherein the fourth accommodation groove is formed on the third engagement section, the second fitting element further has a second trench defined on an outer wall of the fourth engagement section, and the socket has at least one second positioning element mounted in the communication groove thereof and located in the second trench so as to limit a sliding distance of the second fitting element.

The spring is accommodated in the communication groove and abuts against the first fitting element and the second fitting element by using two ends of the spring respectively so that the first engagement section and the second engagement section flush with a first opening of the first accommodation groove and a second opening of the second accommodation groove individually.

Preferably, the socket further has two slots formed adjacent to two ends of the communication groove respectively, and the first positioning element and the second positioning element are two C-rings received in the two slots individually, wherein the first fitting element has a first tilted guide face formed on an edge of the second engagement section, and the second fitting element has a second tilted guide face formed on an edge of the fourth engagement section.

### BRIEF DESCRIPTION OF THE DRAWINGS

FIG. 1 is a perspective view showing the assembly of a socket wrench according to a preferred embodiment of the present invention.

FIG. 2 is a perspective view showing the exploded components of the socket wrench according to the preferred embodiment of the present invention.

FIG. 3 is a cross sectional view showing the operation of the socket wrench according to the preferred embodiment of the present invention.

FIG. 4 is another cross sectional view showing the operation of the socket wrench according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

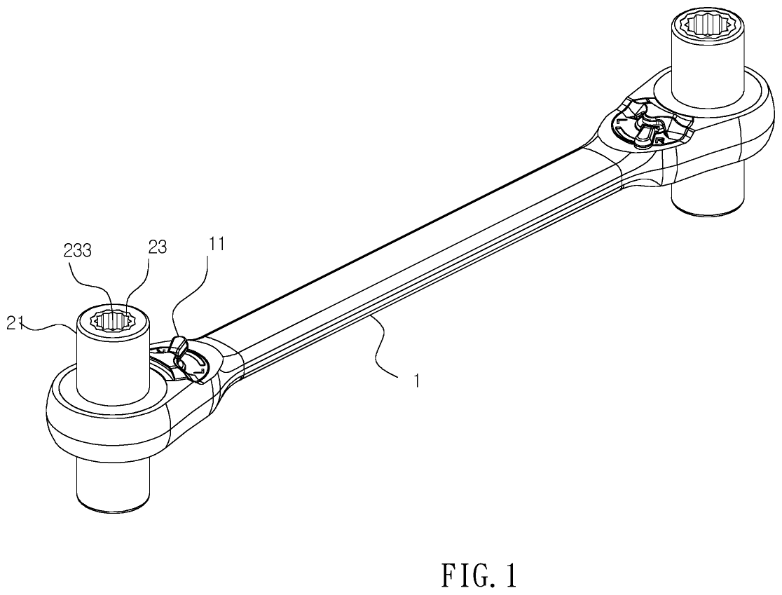

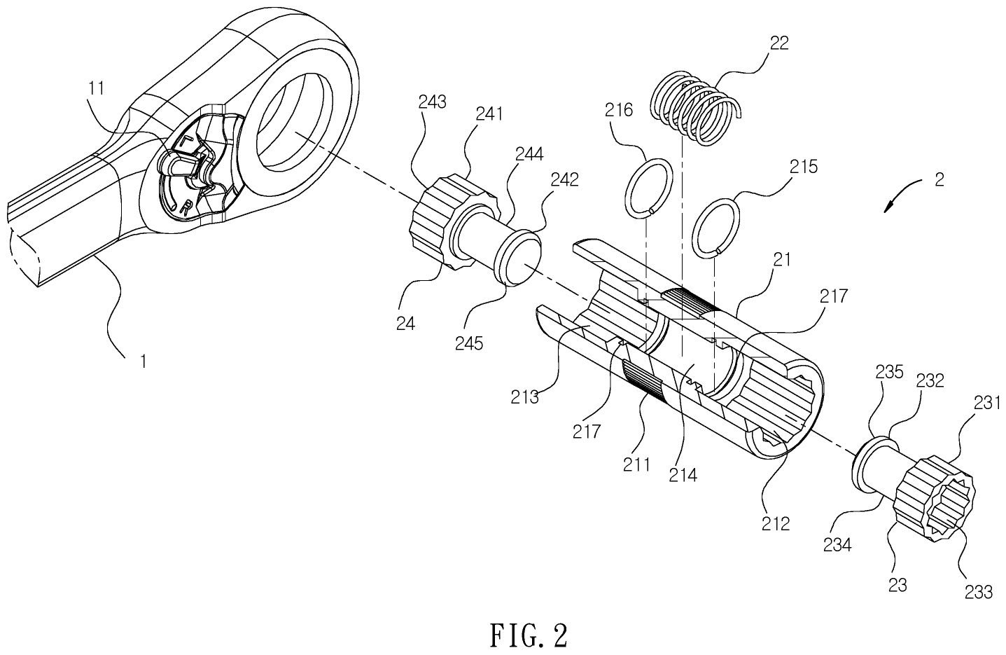

With reference to FIGS. 1-4, a socket wrench according to a preferred embodiment of the present invention comprises: a body 1 and at least one drive assembly 2. In this embodiment, two drive assemblies 2 are accommodated in two ends of the body 1 respectively.

Each of the two drive assemblies 2 includes a socket 21, a spring 22, a first fitting element 23, and a second fitting element 24.

The body 1 includes two control members 11 fixed on the two ends thereof respectively, and the socket 21 has a ratchet section 211 formed on an outer wall thereof so as to mate with each of the two control members 11. Since each control member 11 is well-known art, further remarks are omitted.

The socket 21 has a first accommodation groove 212 and a second accommodation groove 213 which are formed on two ends of the socket 21 individually so as to receive two polygonal workpieces respectively, wherein a diameter of the first accommodation groove 212 is different from that of the second accommodation groove 213 so as to respectively receive the two polygonal workpieces of different sizes. The socket 21 further has a communication groove 214 communicating with and defined between the first accommodation groove 212 and the second accommodation groove 213, wherein the first fitting element 23 is movably accommodated in the first accommodation groove 212 and the communication groove 214, and the first fitting element 23 has a first engagement section 231, a diameter of which corresponds to the first accommodation groove 212. The first fitting element 23 further has a second engagement section 232 fitted with the communication groove 214, wherein a length of the first engagement section 231 is less than a depth of the first accommodation groove 212. The first fitting element 23 further has a third accommodation groove 233, a diameter of which is less than the first accommodation groove 212, and the third accommodation groove 233 is formed on the first engagement section 231. The first fitting element 23 further has a first trench 234 defined on an outer wall of the second engagement section 232, and the socket 21 has at least one first positioning element 215 mounted in the communication groove 214 thereof and located in the first trench 234 so as to limit a sliding distance of the first fitting element 23.

The second fitting element 24 is movably accommodated in the second accommodation groove 213 and the communication groove 214, and the second fitting element 24 has a third engagement section 241, a diameter of which corresponds to the second accommodation groove 213. The second fitting element 24 further has a fourth engagement section 242 fitted with the communication groove 214, wherein a length of the third engagement section 241 is less than a depth of the second accommodation groove 213. The second fitting element 24 further has a fourth accommodation groove 243, a diameter of which is less than the second accommodation groove 213, and the fourth accommodation groove 243 is formed on the third engagement section 241. The second fitting element 24 further has a second trench 244 defined on an outer wall of the fourth engagement section 242, and the socket 21 has at least one second positioning element 216 mounted in the communication groove 214 thereof and located in the second trench 244 so as to limit a sliding distance of the second fitting element 23.

The spring 22 is accommodated in the communication groove 214 and abuts against the first fitting element 23 and the second fitting element 24 by using two ends of the spring 22 respectively so that the first engagement section 231 and the second engagement section 241 flush with a first opening of the first accommodation groove 212 and a second opening of the second accommodation groove 213 individually.

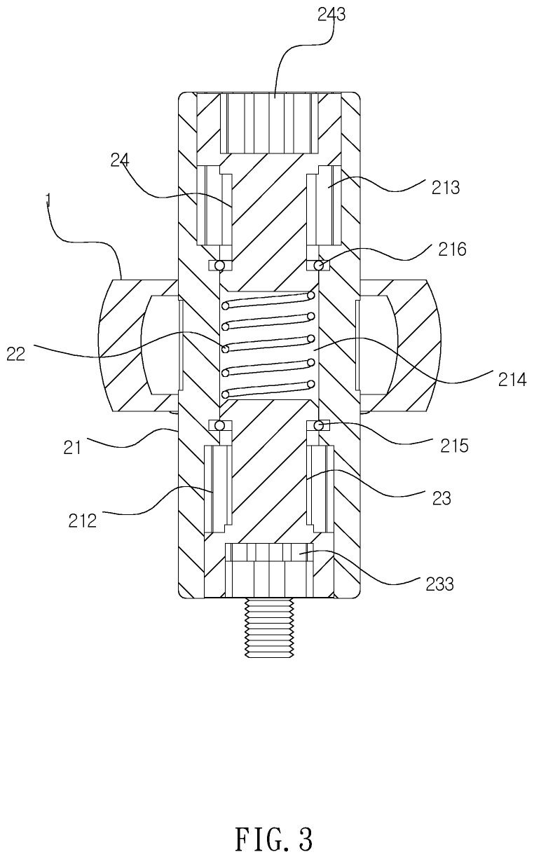

Thereby, the third accommodation groove 233 and the fourth accommodation groove 243 are located on the two ends of the socket 21 individually so as to accommodate the two polygonal workpieces (such as two screw bolts), as shown in FIG. 3.

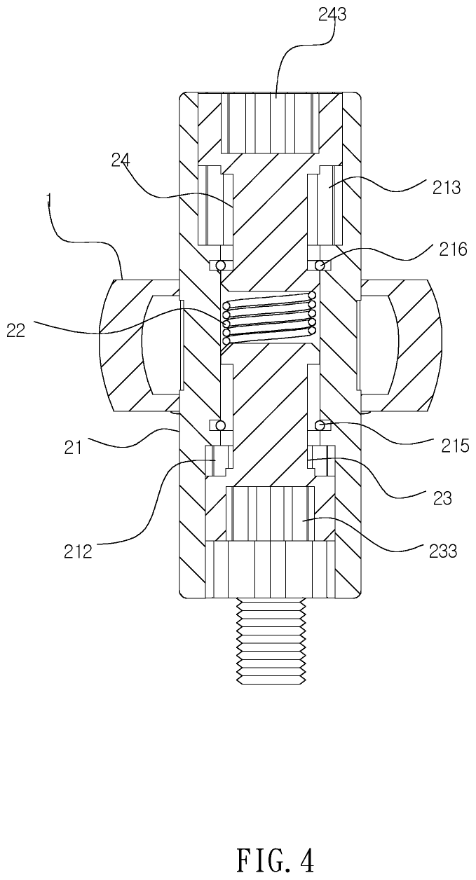

When a screw bolt mates with the first accommodation groove 212 or the second accommodation groove 213, the first fitting element 23 and the second fitting element 24 are pressed to retract inward and to be removed from the first accommodation groove 212 or the second accommodation groove 213, as shown in FIG. 4.

The socket 21 further has two slots 217 formed adjacent to two ends of the communication groove 214 respectively, wherein the first positioning element 215 and the second positioning element 216 are two C-rings received in the two slots 217 individually. The first fitting element 23 has a first tilted guide face 235 formed on an edge of the second engagement section 232, and the second fitting element 24 has a second tilted guide face 245 formed on an edge of the fourth engagement section 242, such that the two C-rings force the first positioning element 215 and the second positioning element 216 to move into the two slots 217 respectively, and the first tilted guide face 235 and the second tilted guide face 245 guide the second engagement section 232 of the first fitting element 23 and the fourth engagement section 242 of the second fitting element 24 to move through and to be retained by the two C-rings individually.

Accordingly, an end of the socket wrench is capable of rotating screw bolts or screws of different sizes by using the first, second, third, and fourth accommodation grooves.

While various embodiments in accordance with the present invention have been shown and described, it is clear to those skilled in the art that further embodiments may be made without departing from the scope of the present invention.

What is claimed is:

1. A socket wrench comprising: a body and at least one drive assembly;
wherein each of the at least one drive assembly includes a socket, a spring, a first fitting element, and a second fitting element;
wherein the body includes two control members fixed on the two ends thereof respectively, and the socket has a ratchet section formed on an outer wall thereof so as to mate with each of the two control members;
wherein the socket has a first accommodation groove and a second accommodation groove which are formed on two ends of the socket individually so as to receive two polygonal workpieces of different sizes respectively, wherein a diameter of the first accommodation groove is different from that of the second accommodation groove, and the socket further has a communication groove communicating with and defined between the first accommodation groove and the second accommodation groove, wherein the first fitting element is movably accommodated in the first accommodation groove and the communication groove, and the first fitting element has a first engagement section, a diameter of which corresponds to the first accommodation groove, the first fitting element further has a second engagement section fitted with the communication groove, wherein a length of the first engagement section is less than a depth of the first accommodation groove, the first fitting element further has a third accommodation groove, a diameter of which is less than the first accommodation groove, and the third accommodation groove is formed on the first engagement section, wherein the first fitting element further has a first trench defined on an outer wall of the second engagement section, and the socket has at least one first positioning element mounted in the communication groove thereof and located in the first trench so as to limit a sliding distance of the first fitting element;
wherein the second fitting element is movably accommodated in the second accommodation groove and the communication groove, and the second fitting element has a third engagement section, a diameter of which corresponds to the second accommodation groove, the second fitting element further has a fourth engagement section fitted with the communication groove, wherein a length of the third engagement section is less than a depth of the second accommodation groove, and the second fitting element further has a fourth accommodation groove, a diameter of which is less than the second accommodation groove, wherein the fourth accommodation groove is formed on the third engagement section, the second fitting element further has a second trench defined on an outer wall of the fourth engagement section, and the socket has at least one second positioning element mounted in the communication groove thereof and located in the second trench so as to limit a sliding distance of the second fitting element;
wherein the spring is accommodated in the communication groove and abuts against the first fitting element and the second fitting element by using two ends of the spring respectively so that the first engagement section and the second engagement section flush with a first opening of the first accommodation groove and a second opening of the second accommodation groove individually.

2. The socket wrench as claimed in claim 1, wherein the socket further has two slots formed adjacent to two ends of the communication groove respectively, and the first positioning element and the second positioning element are two C-rings received in the two slots individually, wherein the first fitting element has a first tilted guide face formed on an edge of the second engagement section, and the second fitting element has a second tilted guide face formed on an edge of the fourth engagement section.
